(19) United States
(12) Patent Application Publication
(10) Pub. No.: US 2007/0053175 A1
(43) Pub. Date: Mar. 8, 2007

(54) Illumination system and display device

(75) Inventors: Erik Paul Boonekamp, Eindhoven (NL); Andreas Martinus Theodorus Paulus Van Der Putten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/570,286

(22) PCT Filed: Aug. 19, 2004
(86) PCT No.: PCT/IB04/51489

§ 371 Date: Feb. 28, 2006

(30) Foreign Application Priority Data
Sep. 4, 2003 (EP) 03103290.7

(51) Int. Cl. G09F 13/04

(52) U.S. Cl. 362/97

(57) ABSTRACT

An illumination system for illuminating a display device (3) comprising a light-emission window (2), a reflector (8) arranged substantially parallel and opposite to the light-emission window, the illumination system having a height h. The illumination system is provided with a plurality of elongate light sources (6, 6′, 6″, . . . ) with diameter d and arranged at pitch p. Each light source is provided with a reflecting layer (7, 7′, 7″, . . . ) for reflecting part of the light emitted by the light source in the direction of the reflector. The reflecting layer forms an elongate concave reflecting surface in spaced relationship with the light source and covers the light source over a covering angle φ, the covering angle φ being in the range, wherein d₁ is the distance between the center of the light source and the reflector. The illumination system has a highly uniform light distribution at the light-emission window.

The invention relates to an illumination system for illuminating a display device.

The invention further relates to a display device comprising said illumination system.

Such an illumination system is referred to as a so-called “direct-lit” backlight or “direct-under” type of backlight illumination system. The illumination systems are used, inter alia, as backlighting of (image) display devices, for example for television receivers and monitors. Such illumination systems can particularly suitably be used as a backlight for non-emissive displays, such as liquid crystal display devices, also referred to as LCD panels, which are used in (portable) computers or (cordless) telephones. The illumination system is particularly suitable for application in large-screen LCD display devices for television and professional applications.

Said display devices generally include a substrate provided with a regular pattern of pixels, which are each driven by at least one electrode. In order to reproduce an image or a datagraphic representation in a relevant area of a (display) screen of the (image) display device, the display device employs a control circuit. In particular, in an LCD device, the light originating from the backlight is modulated by means of a switch or a modulator, while applying various types of liquid crystal effects. In addition, the display may be based on electrophoretic or electromechanical effects.

In the illumination systems mentioned in the opening paragraph, customarily a tubular low-pressure mercury-vapor discharge lamp, for example one or more cold-cathode fluorescent, hot-cathode fluorescent lamps, is used as the light source. In addition, fluorescent lamps with an external electrode or light-emitting diodes (LEDs) may be employed as light source in the illumination system.

In its simplest form, backlights for display devices comprise a number of fluorescent tubes in a rectangular box. On the inside of the box, the walls are covered with a highly reflective (white) coating (preferably, the reflection is higher than 97%). The light-emission window is a diffuser or is covered with a diffuser through which light can escape from the box. In case of a relatively high lamp density (number of lamps per cm), the uniformity of the light output normally is sufficient. However, when the lamp density decreases, the uniformity of the backlight also decreases. In such cases the lamp tubes are readily “visible” through the light-emission window.

The published patent application US-2003/0 107 892 discloses a lamp-reflecting apparatus for use in a “direct-under” type backlight module. The backlight module comprises a plurality of lamps, a diffusing plate disposed above the lamps and a reflecting plate disposed under the lamps. The lamp-reflecting apparatus provided between the lamp and the diffusing plate comprises a reflecting layer for use in reflecting light emitted from the lamps to the bottom reflecting plate. Light non-uniformity resulting from light directly emitted to the diffusing plate directly above the lamps is reduced. A disadvantage of the known illumination system is that the light distribution in the light-emitting panel, particularly in the proximity of the light source, is not sufficiently uniform. As a result, the illumination uniformity of the display device is insufficient.

It is an object of the invention to completely or partly overcome the above-mentioned drawback. The invention more particularly aims at providing an illumination system wherein the uniformity of the light distribution of the illumination system at the light-emission window and hence the uniformity with which the display device is illuminated are improved. According to the invention, an illumination system of the kind mentioned in the opening paragraph for this purpose comprises:

a light-emission window for emitting light in the direction of the display device,

a reflector for reflecting light, the reflector being arranged substantially parallel to and opposite to the light-emission window, the illumination system having a height h being the distance between the light-emission window and the reflector,

a plurality of elongate light sources arranged between the light-emission window and the reflector, the light sources having a diameter d and being arranged at a pitch p with respect to each other,

each light source being provided with a reflecting layer between the light source and the light-emission window for reflecting part of the light emitted by the light source in the direction of the reflector,

the reflecting layer forming an elongate concave reflecting surface in spaced relationship with the light source, the reflecting surface covering the light source over a covering angle φ, the covering angle φ being in the range:

$$180 ° - 2 \cdot arctan \frac{2 ( h - {d}_{1} )}{p} \leq φ \leq 180 ° ,$$

wherein d₁ is the distance between the center of the light source and the reflector.

In order to fabricate an illumination system with a uniform light distribution at its light-emission window, direct light emitted by the light sources in the direction of the light-emission window is partly reflected towards the rear wall of the illumination system. A uniform illumination at the light-emission window of the illumination system is attained by properly tuning the reflectance of the light source. The inventors have found that by properly selecting the number of light sources in the backlight (represented by the pitch p), the placement of the light sources with respect to the reflector (represented by the distance d₁ between the center of the light source and the reflector) and by carefully constructing the shape and size of the reflecting layer adjacent the light source (expressed by the range for the covering angle φ), the distribution of light over the light-emission window can be influenced such that a relatively high uniform illumination of the display device is achieved. A uniformity parameter can be defined (see the detailed description of the embodiments of the invention hereinafter) which, given the above mentioned design parameters, shows a minimum. A minimal uniformity parameter is indicative of a relatively high uniformity of the light emitted by the illumination system according to the invention. A computer program (e.g. employing ray-tracing simulations) can be employed to find out what the best configuration is. Such a computer program can be given certain boundaries for certain parameters, for instance that the height h of the illumination system must not be larger than the height of the conventional illumination system.

The illumination system according to the invention has a light distribution at its light-emission window with a relatively high uniformity. In addition, the illumination system according to the invention is particularly suitable for backlight illumination systems with a relatively small thickness, i.e. with a ratio of the height h of the backlight and the diameter d of the light sources in the range: h/d<2.

Preferably, the covering angle φ is in the range:

$$180 ° - 2 \cdot arctan \frac{3 ( h - {d}_{1} )}{2 p} \leq φ \leq 180 ° - 2 \cdot arctan \frac{( h - {d}_{i} )}{2 p} .$$

In this preferred range for the covering angle φ, the restrictions for the pitch p, the distance d₁ and the height of the illumination system are more severe, resulting in an improved uniformity of the illumination system.

A preferred embodiment of the illumination system according to the invention is characterized in that the ratio of the pitch p of the light sources and the diameter d of the light sources is:

$$1 \leq \frac{p}{d} \leq 4.$$

Preferably, the ratio of the pitch p of the light sources and the diameter d of the light sources is in the range:

$$1.5 \leq \frac{p}{d} \leq 2.5$$

The position of the light sources in the illumination system with respect to the light-emission window and the reflector plays an important role in obtaining a uniform light distribution at the light-emission window. To this end, a preferred embodiment of the illumination system according to the invention is characterized in that the ratio of the distance d₁ from the center of the light source to the reflector and the diameter d of the light sources is:

$$0.5 \leq \frac{{d}_{1}}{d} \leq 1.5 .$$

The upper and lower boundaries are determined by geometrical constraints of the illumination system. When the ratio d₁/d is in the given range backlight illumination system with a ratio h/d≦2 can be realized.

These and other aspects of the invention will be apparent from and elucidated with reference to the embodiment(s) described hereinafter.

In the drawings:

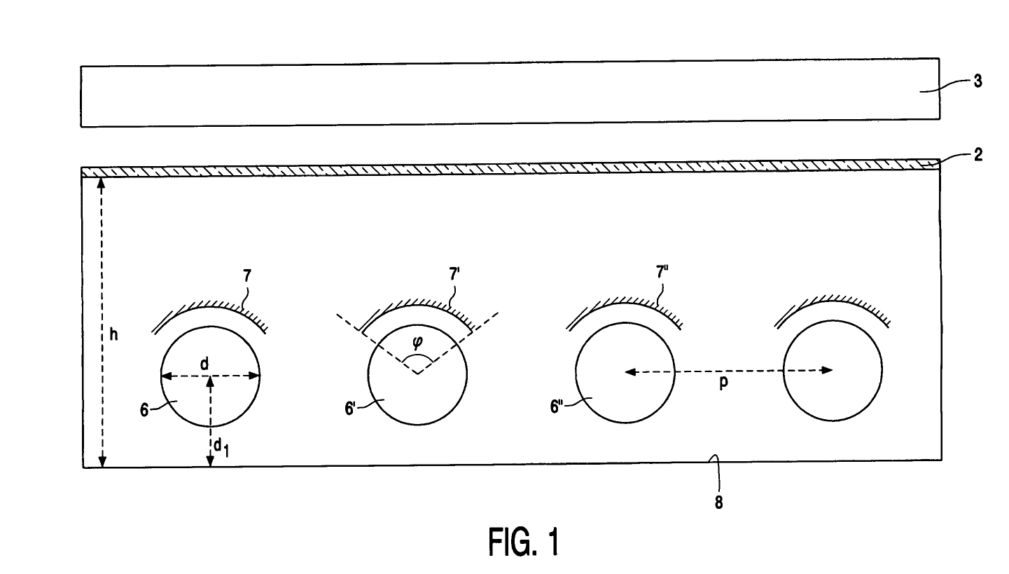

FIG. 1 shows a cross-sectional view of an assembly of an illumination system and a display device comprising an embodiment of the illumination system in accordance with the invention, and

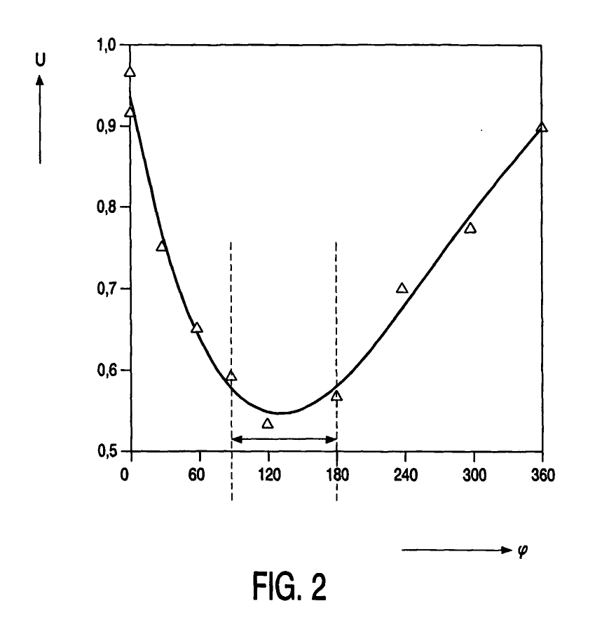

FIG. 2 shows the uniformity parameter as a function of the covering angle for an embodiment of the illumination system according to the invention.

The Figures are purely diagrammatic and not drawn to scale. Particularly for clarity, some dimensions are exaggerated strongly. In the Figures, like-reference numerals refer to like-parts whenever possible.

FIG. 1 is a diagrammatic, cross-sectional view of an assembly of an illumination system and a display device comprising an embodiment of the illumination system in accordance with the invention. The illumination system comprises a translucent light-emission window 2 for emitting light in the direction of the display device 3. To reduce direct visibility of the light sources in the illumination system, the light-emission window is preferably manufactured from a glass or a synthetic resin which preferably scatters the light diffusely. Preferably, the light-emission window 2 comprises a diffusing layer for diffusing the light emitted by the illumination system. The diffusing layer further homogenizes the light emitted by the light-emission window 2.

In FIG. 1, reference numeral 3 very diagrammatically denotes a liquid crystal display (LCD) panel positioned adjacent the light-emission window 2. The assembly of the illumination system with the light sources 6, 6′, 6″, . . . and the LCD panel 3 forms a display device for displaying, for example, (video) images.

The rear wall of the illumination system comprises a reflector 8 with a reflectivity, preferably, higher than 97%. The high reflectivity may also be obtained by coating the walls of the illumination system by suitable diffuse reflecting materials such as TiO₂ or Al₂O₃. Particularly suitable diffuse reflective materials are calcium halophosphate and/or calcium pyrophosphate. Such a reflective material is provided in the form of a paint in which a binder, for example a fluorine copolymer, for example THV, is used, as well as a solvent (for example Mibk). Other additives may be added to the paint mixture, for example those which have improved flowing or mixing characteristics. In addition, the light absorption of visible light of the reflector 8 is very low, i.e. less than 3%. In addition, a diffuse reflective material comprising calcium halophosphate and/or calcium pyrophosphate has substantially no color shift, i.e. such a material has a comparatively low wavelength dependence.

Preferably, the side walls of the illumination system also provided with a similar, highly reflective coating. The rear wall with reflector 8 is arranged substantially parallel to and opposite to the light-emission window 2, the illumination system having a height h being the distance between the light-emission window 2 and the reflector 8.

The illumination system comprises a plurality of elongate light sources 6, 6′, 6″, . . . arranged between the light-emission window 3 and the reflector 8, the light sources 6, 6′, 6″, . . . having a diameter d and being arranged at a pitch p with respect to each other. The light source 6, 6′, 6″, . . . are positioned at a distance d₁ with respect to the rear wall with reflector 8. Preferably, the light sources 6, 6′, 6″, . . . comprise a low-pressure mercury vapor discharge light source or a plurality of parts of low-pressure mercury vapor discharge light sources. Each light source in the illumination system is provided with a reflecting layer 7, 7′, 7″, . . . between the light source 6, 6′, 6″, . . . and the light-emission window 2 for reflecting part of the light emitted by the light source 6, 6′, 6″, . . . in the direction of the reflector 8. The reflecting layer 7, 7′, 7″, . . . forms an elongate concave reflecting surface in spaced relationship with the light source 6, 6′, 6″, . . . . The reflecting surface partly covers the light source 6, 6′, 6″, . . . over a covering angle φ. The reflectivity of the reflecting layer 7, 7′, 7″, . . . can be adapted.

A uniform illumination at the light-emission window 2 of the illumination system is attained by proper tuning the reflectance on the light source 6, 6′; 6″, . . . as a function of position. In particular, by properly selecting the number of light sources 6, 6′; 6″, . . . in the backlight (represented by the pitch p), the placement of the light sources 6, 6′; 6″, . . . with respect to the reflector 8 (represented by the distance di) and by carefully constructing the shape and size of the reflecting layer 7, 7′; 7″, . . . adjacent the light source 6, 6′; 6″, . . . (expressed by the range for the covering angle φ), the distribution of light over the light-emission window can be influenced such that a relatively high uniform illumination of the display device is achieved. A uniformity parameter can be defined which, given the above mentioned design parameters, shows a minimum. A minimal uniformity parameter is indicative of a relatively high uniformity of the light emitted by the illumination system according to the invention.

FIG. 2 shows the uniformity parameter as a function of the covering angle φ for an embodiment of the illumination system according to the invention. The uniformity parameter has been calculated for a typical design of an illumination system according to the invention. The model takes into account the luminance pattern of the light source which, given the selected parameters, results in a “wave-like” illuminance pattern at the light-emission window (employing ray-tracing simulations). The pattern can be influenced by tuning the dimensions of the backlight illumination system, the position of the light sources 6, 6′, 6″, . . . , the covering angle φ and the reflectivity of the reflecting layer 7, 7′; 7″, . . . . In the example of FIG. 2, the height of the illumination system h=28 mm, the pitch of the light sources p=33.6 mm and the position of the light sources relative to the reflector on the rear wall of the illumination system d₁=11 mm. In addition, the reflectivity was taken to be approximately 40%. By way of example, the reflectivity of the reflecting layer 7, 7′; 7″, . . . can be tuned such that the “amplitude” of the wave-like illuminance pattern at the light-emission window reduces to zero. In this manner the uniformity parameter can be defined as the difference in the maximum and the minimum level of the wave-like illuminance pattern as compared to the average illuminance at the light-emission window.

In FIG. 2 it can be seen that uniformity of the light distribution at the light-emission window is relatively low, i.e. the uniformity parameter u is relatively high, if the reflective layer 7, 7′, 7″, . . . is absent (covering angle (φ=0°). In addition, uniformity is also low when the reflective layer 7, 7′, 7″, . . . virtually covers the entire light source 6, 6′, 6″, . . . (covering angle φ≈360°). In between these two extreme values for the covering angle φ, the uniformity parameter u shows a minimum, the minimum being around a covering angle 120°<φ<145°. The range as indicated by the formula for the covering angle φ is indicated as the vertical dashed lines in FIG. 2, the upper boundary being φ=180° and the lower boundary being φ≈90°. Given the dimensions of the example of the illumination system as given hereinabove, these two boundary values for the covering angle φ correspond to the range for the covering angle φ of the embodiment of the illumination system according to the invention:

$$180 ° - 2 \cdot arctan \frac{2 ( h - {d}_{1} )}{p} \leq φ \leq 180 ° .$$

A more preferred range for the uniformity parameter is given by the range according to the preferred range of the covering angle φ:

$$180 ° - 2 \cdot arctan \frac{3 ( h - {d}_{1} )}{2 p} \leq φ \leq 180 ° - 2 \cdot arctan \frac{( h - {d}_{i} )}{2 p} .$$

In the example of the illumination system as given hereinabove (h=28 mm, p=33.6 mm and d₁=11 mm), these preferred boundaries for the covering angle φ are:
106°≦φ≦152°.

Preferably, the ratio of the pitch p of the light sources 6, 6′, 6″, . . . and the diameter d of the light sources 6, 6′, 6″, . . . is:

$$1 \leq \frac{p}{d} \leq 4.$$

There is a range for p/d where no reflectance-angle combination can be found obtaining a sufficient uniform light distribution at the light-emission window 2. Preferably, the ratio of the pitch p of the light sources 6, 6′, 6″, . . . and the diameter d of the light sources 6, 6′, 6″, . . . is in the range:

$$1.5 \leq \frac{p}{d} \leq 2.5$$

The position of the light sources 6, 6′, 6″, . . . in the illumination system with respect to the light-emission window 2 and the reflector 8 plays an important role in obtaining a uniform light distribution at the light-emission window 2. In practice, it was found out that the light sources 6, 6′, 6″, . . . are, preferably, placed relative close to the reflector (rear wall) of the illumination system. Preferably, the ratio of the distance d₁ from the center of the light source to the reflector and the diameter d of the light sources is:

$$0.5 \leq \frac{{d}_{1}}{d} \leq 1.5 .$$

In FIG. 1, the reflective layers 7, 7′, 7″, . . . are depicted as entities separate from the light sources 6, 6′, 6″, . . . . In this case the reflective layers 7, 7′, 7″, . . . are shaped like “caps” and are, preferably, made of glass or Plexiglas. Preferably, the reflecting layer 7, 7′, 7″, . . . comprises a specular reflecting or diffuse reflecting layer. Preferably, the reflecting layer 7, 7′, 7″, . . . is substantially free from absorption. Alternatively, a non-absorbing perforated material can be employed as reflecting layer 7, 7′, 7″, . . . . In a further alternative embodiment the reflective layer 7, 7′, 7″, . . . are formed by applying suitable reflective foils which are laminated directly on part of the light source 6, 6′, 6″, . . . . In a still further favorable embodiment the reflecting layer 7, 7′, 7″, . . . is provided with brightness enhancement means. In an embodiment of this brightness enhancement means, grooves are applied which are preferably, oriented in the length direction of the light sources 6, 6′, 6″, . . . . In yet another embodiment the reflective layer 7, 7′, 7″, . . . is spray coated or sputter coated directly on the light source 6, 6′, 6″, . . . . It may be advantageous for obtaining a further improved uniform light distribution at the light-emission window 2 to provide the reflecting layer 7, 7′, 7″, . . . with openings for emitting part of the light emitted by the light source 6, 6′, 6″, . . . in the direction of the light-emission window 2. This may be done by scraping or removal by means of a laser.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An illumination system for illuminating a display device (3), the illumination system comprising:
a light-emission window (2) for emitting light in the direction of the display device (3),
a reflector (8) for reflecting light, the reflector (8) being arranged substantially parallel to and opposite to the light-emission window (2), the illumination system having a height h being the distance between the light-emission window (2) and the reflector (8),
a plurality of elongate light sources (6, 6′, 6″, . . . ) arranged between the light-emission window (3) and the reflector (8), the light sources (6, 6′, 6″, . . . ) having a diameter d and being arranged at a pitch p with respect to each other,
each light source (6, 6′, 6″, . . . ) being provided with a reflecting layer (7, 7′, 7″, . . . ) between the light source (6, 61, 6″, . . . ) and the light-emission window (2) for reflecting part of the light emitted by the light source (6, 6′, 6″, . . . ) in the direction of the reflector (8),
the reflecting layer (7, 7′, 7″, . . . ) forming an elongate concave reflecting surface in spaced relationship with the light source (6, 6′, 6″, . . . ), the reflecting surface covering the light source (6, 6′, 6″, . . . ) over a covering angle φ, the covering angle φ being in the range:
$$180 ° - 2 \cdot arctan \frac{2 ( h - {d}_{1} )}{p} \leq φ \leq 180 ° ,$$
wherein d₁ is the distance between the center of the light source (6, 6′, 6″, . . . ) and the reflector (8).

2. An illumination system as claimed in claim 1, characterized in that the covering angle φ is in the range:
$$180 ° - 2 \cdot arctan \frac{3 ( h - {d}_{1} )}{2 p} \leq φ \leq 180 ° - 2 \cdot arctan \frac{( h - {d}_{1} )}{2 p} .$$

3. An illumination system as claimed in claim 1, characterized in that the ratio of the pitch p of the light sources (6, 6′, 6″, . . . ) and the diameter d of the light sources (6, 6′, 6″, . . . ) is:
$$1 \leq \frac{p}{d} \leq 4.$$

4. An illumination system as claimed in claim 3, characterized in that the ratio of the pitch p of the light sources (6, 6′, 6″, . . . ) and the diameter d of the light sources (6, 6′, 6″, . . . ) is in the range:
$$1.5 \leq \frac{p}{d} \leq 2.5 .$$

5. An illumination system as claimed in claim 1, characterized in that the ratio of the distance d₁ from the center of the light source (6, 6′, 6″, . . . ) to the reflector (8) and the diameter d of the light sources is:
$$0.5 \leq \frac{{ⅆ}_{1}}{ⅆ} \leq 1.5 .$$

6. An illumination system as claimed in claim 1, characterized in that the reflecting layer (7, 7′, 7″, . . . ) comprises a specular reflecting or diffuse reflecting layer.

7. An illumination system as claimed in claim 1, characterized in that the reflecting layer (7, 7′, 7″, . . . ) is provided with brightness enhancement means.

8. An illumination system as claimed in claim 1, characterized in that the reflecting layer (7, 7′, 7″, . . . ) is provided with openings for emitting part of the light emitted by the light source (6, 6′, 6″, . . . ) in the direction of the light-emission window (2).

9. An illumination system as claimed in claim 1, characterized in that the light sources (6, 6′, 6″, . . . ) comprise a low-pressure mercury vapor discharge light source or a plurality of parts of low-pressure mercury vapor discharge light sources.

10. An illumination system as claimed in claim 1, characterized in that the light-emission window (2) comprises a diffusing layer for diffusing the light emitted by the illumination system.

11. A display device (3) comprising an illumination system as claimed in claim 1.
